(19) United States
(12) Patent Application Publication
(10) Pub. No.: US 2006/0116970 A1
(43) Pub. Date: Jun. 1, 2006

(54) System and method to grant or refuse access to a system

(76) Inventors: Helmut Scherzer, Tuebingen (DE); Elaine Palmer, Goldens Bridge, NY (US)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/274,619

(22) Filed: Nov. 15, 2005

(30) Foreign Application Priority Data
Nov. 18, 2004 (EP) 04105897.5

(51) Int. Cl. G06Q 99/00; G06K 9/00

(52) U.S. Cl. 705/74; 340/5.52; 235/382; 340/5.65; 382/115

(57) ABSTRACT

A new system to grant or refuse access to a system, comprising a portable access device communicating with a terminal of an access point, wherein the portable access device comprises a storage means. A set of trust parameters is stored on the storage means, the set of trust parameters being used to evaluate the amount of service and/or functionality of the system being granted to the user presenting the trust parameters on the portable access device, wherein the evaluation and the decision, whether to grant or refuse access to the system is made as a result of computation of the trust parameters without revealing the identity of the user.

### FIELD OF THE PRESENT INVENTION

The present invention relates to a system to grant or refuse access to a system, comprising a portable access device communicating with a terminal of an access point, wherein the portable access device comprises a storage means. The present invention relates further to a method to grant or refuse access to said system, comprising authentication of a user in an anonymous way.

### BACKGROUND OF THE PRESENT INVENTION

The tragic events of Sep. 11th, 2001 have raised the attention of people, governments and institutions for technical means to protect facilities and persons from threats. While technology can only help to cover a minor aspect of the entire problem, different discussions have evolved since that day. The ‘Homeland’ discussion focuses on the electronic passport and new workgroups have been established to discuss the application of biometric methods for identification, to name just two of those activities.

### STATE OF THE ART

SmartCards might play a significant role in this discussion, because their form factor and their technical features satisfy many demands of an electronic support for personal and system security. While a major application field of SmartCards has been the electronic payment, in particular in Europe (Geldkarte, MONEO), still the credit card companies focus on the payment aspect of the SmartCard technology. Personal/system security has become a new issue for SmartCards besides the health sector. Last but not least, SmartCards might become popular under the aspect of electronic signatures; European standards are currently set up, as the legal settlements have been done in Europe to allow this technology to be applied. Electronic signatures could be valuable in all the other aspects of SmartCard usage, health, payment and security.

The new demand in security does, however, have some implications, that require an additional political discussion. One of these aspects is the privacy discussion. Do the requirements of security justify the ‘transparent citizen’? Given that SmartCards will become involved in many domains of daily life (e.g. building access), the identity of persons might be revealed in these situations, in particular if contactless SmartCards are used, where a person does not explicitly express his or her will to use that technology, accepting the consequences implicitly. To prove trustability, a database might have to be involved that uses the identity of a person to find a trustability record. It appears obvious that this centralized approach has some dangerous implications to an ethical application of technology.

It is certainly a wrong assumption to claim that giving up identity protection and privacy is tolerable if a person is honestly minded and does not have doubtful ambitions. For instance, a broker might anonymously want to visit a company to get an idea for an investment. Revealing his identity could have an unwanted impact on the stock; privacy needs to be protected in this case as part of the public interest. There are certainly lots of situations that could be brought up under this aspect. For example, the ‘transparent citizen’ could be a threat on its own, given that government's and institution's ambitions are often in conflict with the public interest. Therefore, there is a demand on the citizen's side to protect her/his anonymity as much as possible and reasonable. That seems to be in contradiction with proving trustability, which is, of course, related to the identity and presence of a person. The presentation of a SmartCard alone does not provide any evidence of trustability. While for payment transactions, banks can argue that the possession of a secret quantity (password) is sufficient to prove legislation for the payment, the protection of people and buildings can obviously not rely on this quality. Stronger means of identification have therefore to be applied. Biometric methods are the answer to this question. However, in particular biometric methods would allow identifying a person.

### OBJECT OF THE PRESENT INVENTION

Starting from this, an object of the present invention is to provide a system and a method to grant or refuse access to a system, comprising authentication of a user in an anonymous way, thereby avoiding the disadvantages of the prior art. A special problem is how to prove the trustability of a person, while maintaining her/his anonymity.

### BRIEF SUMMARY OF THE INVENTION

The present invention provides a new system to grant or refuse access to a system, comprising a portable access device communicating with a terminal of an access point, wherein the portable access device comprises a storage means. The present invention further provides a new method to grant or refuse access to a system, especially a service, comprising authentication of a user in an anonymous way.

The new system is characterized in that a set of trust parameters is stored in the storage means, said set of trust parameters being used to evaluate the amount of service and/or functionality of the system being granted to the user presenting the trust parameters on the portable access device, wherein the evaluation and the decision whether to grant or refuse access to the system is made as a result of computation of the trust parameters without revealing the identity of the user. The coupling of the access device to the access point may be galvanic or contactless. The set of trust parameters does not represent a form of access conditions of its own, i.e. it can not be determined from the presented trust parameters whether a service or functionality might be granted or not. Preferably, the trust parameters are transferred to a terminal in an anonymous way.

A preferred embodiment of the system is characterized in that the portable access device is a smart card or chip card that holds at least part of the trust parameters. The Card is owned by the person to be granted the service.

The new method is characterized in that an algorithm is used to evaluate the actual access rights of the user from the set of trust parameters in an anonymous way. The algorithm is subject to change due to the political situation, social terms, legal aspects and/or other parameters. The mutual recognition of other nations, sectors or domains may be part of this evaluation algorithm. The evaluation criteria may be updated and changed if need shall arise. The present invention solves the contradiction of positive identification while keeping anonymity of a person.

A preferred embodiment of the method is characterized in that the trust parameters are updated/initialized by a link to a registration instance. The update/initialization may be performed automatically.

A further preferred embodiment of the method is characterized in that a biometric verification is performed to authenticate the user before the set of trust parameters is presented, while the identity of the user remains protected. Biometric verification of the user may be performed through different methods. Preferably, only the result of authentication is sent to the system. Only the information that the user is identical to the card holder is sent to the system. No information about the identity of the user is sent to the system.

A further preferred embodiment of the method is characterized in that a mutual authentication is performed to assure that a genuine access device is communicating to a genuine access point. Public key cryptography may be chosen to perform the mutual authentication. A group certificate may be used that is assigned to a service system, and not to the particular card holder.

Further preferred embodiments of the method are characterized in that the access point or the access device performs a biometric scan. Preferably fingerprint scan, retina scan, voice recognition and/or static and dynamic signature verification are used for biometric verification.

Further preferred embodiments of the method are characterized in that biometric verification is performed by the access device or the access point. The present invention optionally uses ‘biometric verification’ to let an access device, especially a SmartCard, obtain evidence of the fact that a presenter of the access device is identical to the holder of the access device, i.e. to the person, that owns the trust parameters. Biometric verification therefore links the quality that results from the trust parameters, to the person, who actually uses the access device to present her/his trustability. The biometric verification process is protected through security methods to protect against eavesdropping and manipulation of data.

A further preferred embodiment of the method is characterized in that the access point sends at least part of the scanned biometric information of the user to the access device. In general the access device shall be involved in the verification process to have evidence that a positive verification is made based upon the actual access device holder's biometric parameters.

A further preferred embodiment of the method is characterized in that biometric reference parameters are stored in the access device. The reference parameters are used for the verification of the user.

A further preferred embodiment of the method is characterized in that the user is verified and linked to the biometric reference parameters kept in the access device. The biometrical parameters might be pre-computed or compressed by the access point to optimize the performance for the verification. Also the access point might assist the Access device in verifying the biometric data stream.

A further preferred embodiment of the method is characterized in that the access device performs the final decision whether the scanned biometric data matches the biometric reference data stored in the access device. After the access device has successfully verified the biometric parameters, the access device sends the trust parameters to the access point.

A further preferred embodiment of the method is characterized in that the evaluation and the decision whether to grant or refuse access to the system is performed in the access point. The access point evaluates the trust parameters and might possibly request another set of trust parameters from the access device.

The present invention relates further to a computer program product stored in the internal memory of a digital computer, containing parts of software code to execute the above described method.

### BRIEF DESCRIPTION OF THE DRAWINGS

The above, as well as additional objectives, features and advantages of the present invention will be apparent in the following detailed written description.

The novel features of the present invention are set force in the appended claims. The invention itself, however, as well as a preferred mode of use, further objectives, and advantages thereof, will be best understood by reference to the following detailed description of an illustrative embodiment when read in conjunction with the accompanying drawings, wherein:

FIG. 1 shows the proposed method;

FIG. 2 shows an example of a trust record and

FIG. 3 shows an example for a process of trustability verification.

In general, a person A trusts another person B, if A has evidence about the some qualities of the counterpart. These qualities may be, ‘knowing’ B for a certain amount of time, having seen B acting (e.g. drive a car) etc. After person A ‘knows’ person B for driving a car carefully, she might be willing to lend B her car for the weekend.

Trustability requires knowledge of ‘trust parameters’. If a stranger C asks person A to lend him the car for the weekend, A may not be able to get sufficient evidence, whether C drives the car carefully, whether his income is stabile and high enough to cover a possible car accident etc. So A will refuse to lend her car as the amount or quality of trust parameters is not sufficient. A stranger C might now feel discriminated by the fact, that he is an honest person, but not equally treated by A in demanding the car. In fact, C is ‘filtered’ from the set of persons, that might borrow A's car.

The technical protection of people and material from threat can be achieved by ‘filtering’. If a terrorist has access to a public library, he can of course place a bomb. So if technology is involved in the protection of people and material, filtering is the price to be paid. The political and technical challenge is to find an optimum filter, that minimizes the rejection of trustable person and maximizes the rejection of persons with unacceptable ambitions, in our case described as ‘non-trustable persons’.

It is clear, that trustability does not necessarily guarantee honest ambitions, however this connection needs to be made to approximate a ‘filter’ that can withstand an ethical discussion. In particular, ‘trust parameters’ reveal a social quality. It is therefore extremely important to protect the identity of a person; if a person is rejected from a process (e.g. access to a building) the person would certainly not want to have her identity revealed. The protection of a person's identity is a minimum ethical requirement to keep discrimination as low as possible.

The present invention uses ‘trust parameters’ that can be filtered by a system to decide whether a service is granted to a card holder or not. The present invention does not propose a particular set of trust parameters, certainly a political/social and ethical discussion might have to determine the correct establishment of parameters. Hence the parameters given in this invention may only be regarded as examples to demonstrate the functionality of a system that verifies trustability.

Possible parameters used in this proposal are:

the number of years a person has lived in the same place;

the family status (married, number of children);

the local registration;

the employment situation;

the income;

the criminal record history;

a list of positive acknowledgements from (trustable) persons who trust the card holder.

The list of trust parameters is very ‘personal’, however, this compared to real life situations, is similar to what determines why a person A trusts another person B. Therefore, despite the intimacy of these parameters, they are quite realistic to determine the trustability of a person. In general, many of these parameters are registered in government records anyway.

The present invention proposes a method and system to grant or refuse a service to a holder of a smartcard. The smartcard is owned by the person to be granted the service. On the smartcard are stored biometric reference data and trust parameters.

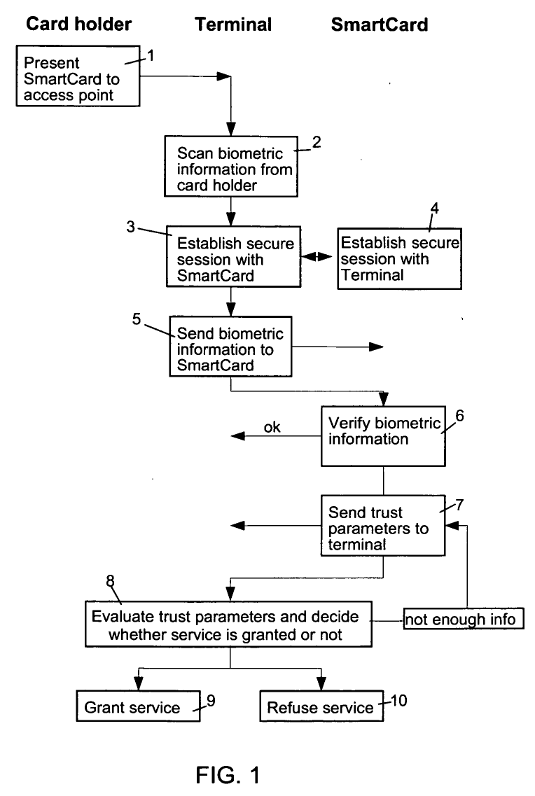

FIG. 1 shows the proposed method with reference to steps 1 to 10. In step 1, the card holder presents the smartcard to the access point. The coupling can be galvanic or contactless. In step 2, the access point (terminal) performs a biometric scan. The biometric scan can also be performed by the smart card. Any trustable biometric method may be applied. The minimum required mandatory input data to the smartcard is a set of biometric parameters, taken from a biometric sensor (e.g. fingerprint, voice recording, retina scan).

In steps 3 and 4, the terminal negotiates a secure session with the smartcard to avoid eavesdropping and tampering with the information to be exchanged. The secure session is necessary to avoid security threats to the data in the smartcard.

If a smartcard is presented to any service access point, the terminal and smartcard require a mutual authentication to assure, that a genuine smartcard is communicating to a genuine terminal. If public key cryptography is chosen, the card's certificate must not reveal any identity, e.g. it could be a group certificate that is assigned to the service system, not to the particular card holder. The input/output flow of such a device authentication protocol is recommended to follow current existing standards (e.g. ESIGN-K European Signature standard, also known as CWA 14890). As the terminal will trust the smartcard's ‘trust point record’ it must be assured, that the smartcard is an authentic card. Therefore the establishment of a secure session (device authentication) is a mandatory part of the verification process. The terminal shall not be able to derive identification from the data transmitted during mutual device authentication.

Exchange of biometric parameters has to take place after successful device authentication. If e.g. fingerprint sensor is located on the smartcard, this input is immediately evaluated within the smartcard. If the sensor is located outside, the extracted biometric data needs to be sent to the smartcard via its communication channel (either contactless or contact driven). The actual content of the biometric data depends on the system and is not relevant for the support of the idea of this invention.

The verification of the biometric parameters is performed either exclusively in the smartcard, or with the support of the terminal. In general the smartcard shall be involved in the verification process to have evidence that a positive verification is made based upon the actual card holder's biometric parameters. According to the present invention, it is important, that the card holder is correctly verified and linked to the biometric parameters kept in the smartcard.

In step 5, the terminal sends (part of the) biometric information to the smartcard. The smartcard compares the biometric input data with the reference data and generates a Yes/No answer, whether the input data matches the reference data. The minimum output of this process step is a response from the smartcard that transports this information. The response needs to be protected under a secure messaging channel to avoid tampering with this information. In addition, the next step (send trust information) may be combined with sending the OK status.

In step 6, the smartcard verifies (part of) the biometric data stream. The biometric parameters might be pre-computed or compressed by the terminal to optimize the performance for the verification. Also the terminal might assist the smartcard in verifying the biometric data stream. It shall, however, be the smartcard that performs the final decision whether the biometric data matches the biometric reference stored in the smartcard.

After the smartcard has properly verified that the biometric reference data match the presented biometric input data, the terminal might request (parts of) the trusted information set. The request token, sent to the smartcard may contain identifiers to what part of the trust information is desired. The trust information record may be categorized in different application fields like:
Banking related trust evidence.
Social establishment trust evidence.
History trust evidence.
Familiar status trust evidence.
Traffic related trust evidence.
Profession related trust evidence.
Etc.

A ‘trust info request token’ may either request all categories or parts of it relevant to be known for the requested service in question. The smartcard responds with the requested trust information. The selection of categorized trust information may be realized with standard access commands like READ FILE, or can be made more interactively with a proprietary command that filters the relevant records from a set of trust information. The smartcard's response shall be protected by secure messaging mechanisms (cryptographic checksum) to avoid tampering with this information during processing.

In step 7, the smartcard sends the trust parameters to the terminal. The exact amount and categories of the trust parameters might vary depending on some request information sent by the terminal. This invention claims in general the idea of a selective set of trust parameters to maintain the privacy of the card holder to a maximum.

In step 8, the terminal evaluates the received trust parameters and might possibly request another set of trust parameters from the smartcard by returning to Step 7. The evaluation algorithm is a program that receives the trust parameters from the smartcard and that contains a profile according to which it evaluates the final result, whether or to what extend the service is granted. The evaluation profile is a set of data that may change dynamically, depending on the political situation, security alerts, time of day and year, and other determining parameters.

An off-line terminal might connect to a background system to update its evaluation profile. The usage of a profile that can be dynamically updated is one of the major claims of this invention. Another important claim is the fact, that a card holder does not actually store his/her credentials, but a set of values that ‘create’ the credentials after they have been passed to the terminal. The representation of trust does not convey the flavour of ‘access’, but is a parameter to compute the access credential in the process of the evaluation algorithm.

The background system is an optional part and used, if additional information is required by the terminal, e.g. an update of evaluation thresholds or the evaluation of trust parameters itself if the terminal is not designed to perform this action. Input and output to the background system are application specific, as the core idea of the invention does not mandate a background system to function. The subject of the invention can be described without the particular need of the background system. However, the use and purpose of a background system is mostly related to the dynamic update of the trust evaluation algorithm in the terminal.

The algorithm and its related threshold for the decision whether the access is granted or not may depend on the political situation, day time or economical aspects among others. Whenever the situation requires a change or adaptation of the trust evaluation algorithm a terminal might connect to the background system and exchange information to update of the evaluation algorithms parameters.

In step 9, the terminal has obtained sufficient information from the smartcard and decides to grant the desired service to the card holder. When the grant of service is given or rejected, the card holder will be informed appropriately. According to the assumptions above the identity of the person is kept confidential and does not leak to the terminal nor the background system.

In step 10, the terminal could not compute a sufficient trust level to grant the service to the card holder. As a consequence a number of possible reactions is proposed:

Full reject of service including a security alert.

Full reject of service without a security alert.

Partial reject of service, only non-critical aspects of the service are granted.

Manual verification, the card holder is sent to an administration point where (s)he might ask for a personal investigation to finally get the service granted; at this time, anonymity might not be protected anymore;

Delayed grant of service after requesting additional parameters (both faced, by the terminal and/or the card holder).

In the system according to FIG. 1, the trust parameters 7 are not a direct representation of credentials, but are evaluated with algorithm 8 that derives the actual credentials, using a profile. The profile may be subject to update, depending on political, economical or other conditions. The present invention relates also to a system that protects the privacy of the card holder by presenting the biometric scan data to the smartcard to determine the presence of the card holder and return the result to the terminal using a secure channel.

A significant difference between normal access systems is, that the access rights of a user are typically pre-determined and initialized on her/his access device (smartcard). The objective of the access point is then only to verify whether this pre-determined set of parameters matches the conditions set to access/obtain a service. The proposed system, however, presents a set of individual parameters, formed by the collection of trust parameters. Trying to compare these trust parameters to the classical representation of ‘access rights’ would lead an observer to the conclusion, that none of trust parameters could be considered as an access right on its own, as it is not related to a matter of access at all. Therefore a system has to provide a particular algorithm to evaluate the actual access rights from the set of trust parameters. This algorithm is subject to change due to the political situation, social terms, legal aspects and other parameters. The mutual recognition of other nations, sectors or domains may be part of this evaluation algorithm. The evaluation criteria may be updated and changed if need shall arise.

In general the smartcard has a command set rich enough to realize the functions described above. If the command set according to ISO 7816-4 is used, then device authentication can be performed with the MANAGE SECURITY ENVIRONMENT, PERFORM SECURITY OPERATION, READ RECORD, EXTERNAL AUTHENTICATE and INTERNAL AUTHENTICATE commands as described in CWA 14890. Biometric parameter transmission can be performed with the VERIFY command. Reading trust information can be performed with READ BINARY, READ RECORD commands. If special filtering of trust information is to be performed in the card, then a proprietary command might have to be used instead.

The personalization of the smartcard is not different from state of the art personalization of today's smartcards. Personalization is typically done under high security restrictions and in protected sites. It is assumed that the trust information is recorded on the smartcard according to the high security standards of today's personalization schemes.

A more important aspect to this topic is the update of trust information. Unlike an electronic purse, the qualities stored in the card, related to trust, may well change over the time. The change in the trust record is not likely to happen very often, however, in situations, where a person moves from A to B, the trust record is likely to change. The update of trust data may happen centralized or decentralized. In the centralized approach, a ‘trust delivery center’ administers the card holder's parameter and allows to download an update through available communication devices (e.g. Internet, Banking terminal etc.). Here the problem to solve is, how the trust delivery center will receive the entire diversity of trust aspects by contacting the related legal and economical institutions. Ideas helping with that aspect might have been laid out under the general idea of “e-community”. Participants of the trust scheme (like a bank, administration, company) might maintain a subscription to the trust delivery center such that they might automatically update the trust delivery center on changes of a card holder's trustability. The card holder him/herself might apply for this service when e.g. subscribing for a bank account.

The centralized update is favourite for the card holder since (s)he might easily update the present score of trust with conventional methods, e.g. home terminal with smartcard reader.

The de-centralized architecture would require the card holder to visit the different entities to get her/his trust record updated appropriately. In the example of banking related trust information, this can be done automatically when the card holder sticks her/his card into an ATM (Asynchronous Transfer Mode) machine to withdraw money. Accordingly the update can always be done automatically when a card holder ‘contacts’ the related entity. The advantage of this architecture is, that no trust delivery center is required.

The disadvantage of the decentralized architecture is, that the update of trust information largely depends on the card holder's behaviour, whether and when (s)he gets in contact with the related trust information provider, the user might not even know who and where these trust providers are.

The technical update of trust information is straight forward according to existing security technologies and does not need to be described in further detail. Similar device authentication protocols as described for the access process shall be used to assure the integrity and confidentiality of the trust data.

A further thought is the idea of instant reference update. For instance a person buys a medicine at a pharmacy. This transaction might immediately be recorded at the pharmacy to collect more information that constitutes the trust record. The transaction information might be kept and accumulated until the card holder visits a ‘trust access point’ (Internet, Bank etc.) that is entitled to transform the transaction information into a corresponding trust contribution.

A combination of trust verification and transaction update might be performed, e.g. a person needs to be ‘trust verified’ when entering a library and a transaction record might hold the information “rented a book” to account the card holders activity. Having rented and returned a book many times might finally account for an increased trust of the library to the customer. The library might use that transaction information to update the ‘library trust’ related record with some points regularly.

To achieve confidence and authenticity on the transmission of the sensitive data a device authentication is established when the SmartCard (ICC) is connected to an access point (IFD=Terminal). A so called ‘privacy protocol’ enhances the key transport protocol by a Diffie-Hellman key negotiation, prior to the authentication. The identity of the ICC is not revealed to the IFD since the ICC's certificate does not contain any personal related information. The serial No. of the ICC can be any random value generated by the ICC to avoid a library search attack to reveal its identity. Usage of the privacy protocol mandates to authenticate the IFD first.

After successful completion of the device authentication commands and responses are transferred in the SM mode as specified by access conditions. The derived or negotiated symmetric keys will be used to protect integrity and/or confidentiality of the information being transmitted on the interface to the external world or vice versa. If not all commands are used with secure messaging, as a consequence the unprotected messages can be forged by an attacker. For compatibility reasons to existing applications the usage of secure messaging for any command cannot be mandated, although it is highly recommended.

Static SM is another option, using a symmetric key being reserved for secure messaging. In the case of static SM the keys are always available in the card. A key agreement/derivation method is therefore not required. By application of Secure Messaging the format of a plain text message will change according to the definitions in ISO/IEC 7816-4 [11] when it is transmitted with secure messaging.

The presence of Secure Messaging is indicated in b3 and b4 of the CLA byte of the command APDU. According to ISO/IEC 7816-4, chapter 6.2.3.1 the bits b3 and b4 are set to 1 indicating that the command header is included in the message authentication. If Secure Messaging is applied the command and response message shall be TLV coded. The cryptographic checksum shall integrate any secure messaging data object having an odd tag number.

Further SM status bytes can occur in application specific contexts. When the ICC recognizes an SM error while interpreting a command, then the status bytes must be returned without SM.

The padding mechanism acc. to ISO/IEC 7816-4 [11] (‘80 . . . 00’) is applied for checksum calculation.

Cryptograms are built with TDES in CBC-Mode with the Null vector as Initial Check Block. A cryptogram (Tag=‘87’x) is always followed by a cryptographic checksum with Tag=‘8E’x. Encryption must be done first on the data, followed by the computation of the cryptographic checksum on the encrypted data. This order is in accordance with ISO/IEC 7816-4 [11] and has security implications as described in [39]. The command header shall be included in to the cryptographic checksum. The actual value of Lc will be modified to Lc′ after application of secure messaging. If required, an appropriate data object may optionally be included into the APDU data part to convey the original value of Lc.

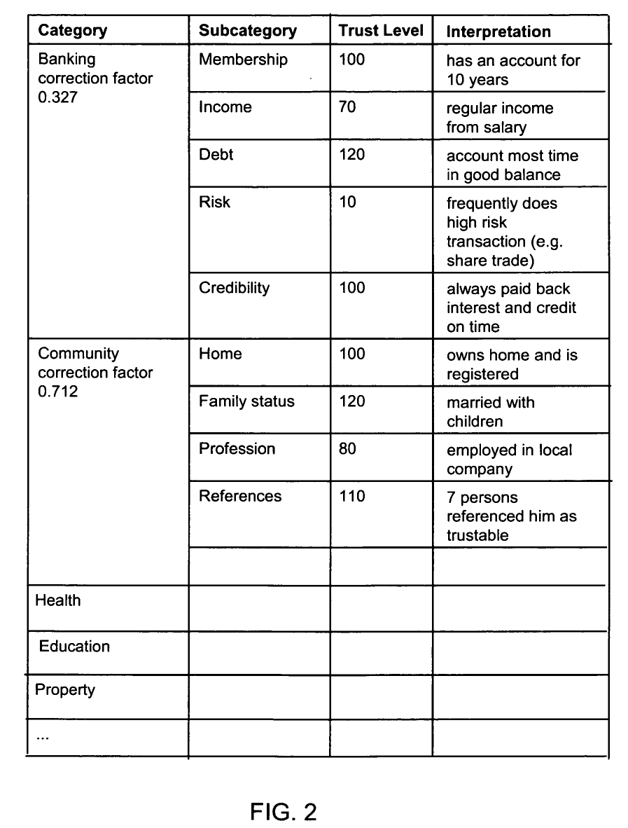

FIG. 2 shows an example of a trust record. A simplified form of trust parameter representation can be a set of categories, each of them containing a count that represents an amount of trustability related to its category. However, it seems more likely to desire a higher granularity; therefore, as an example, the structure in FIG. 2 is proposed for the feasibility demonstration of the proposed system.

The example of FIG. 2 demonstrates a generic approach for a trust record. It is very obvious that the information carried in the record is most sensitive, which is the general nature of trust information anyway.

Categories are used to possibly restrict the set of parameters that a terminal might be allowed to access. On device authentication a terminal might have to present its credentials that might restrict the access to categories of the trust record.

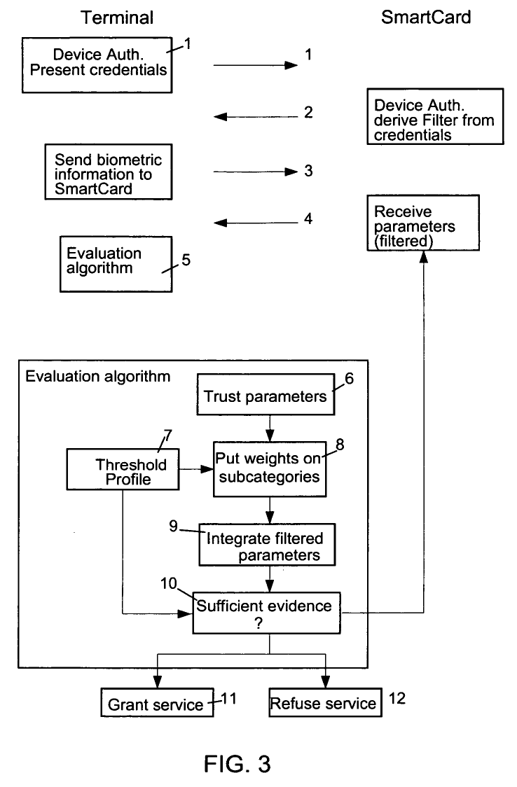

For the example shown in FIG. 2 a terminal might only have access to the Banking category. Hence the evaluation algorithm can only use those parameters for its decision. A more generic approach is given in the FIG. 3.

FIG. 3 shows an example for a process of trustability verification. In steps 1 and 2, the terminal and the smartcard exchange credentials. In steps 3 and 4, the terminal and the smartcard exchange biometric information. An evaluation algorithm 5 is used to evaluate trust parameters 6. The evaluation algorithm 5 derives particular weights from a threshold profile 7. The weights are factors for the values stored in the particular subcategories. The weights could be normalized i.e. to maintain the correct mathematical properties. In step 8, weights are put on the subcategories. In step 10, the sum 9 of the accumulated weighted ‘trust points’ may be compared with a given threshold provided by the threshold profile 7. If the accumulated sum exceeds the threshold, the service might be granted in step 11 without further interaction. If the accumulated sum does not exceed the threshold, the service will be refused in step 12.

The algorithm above may be subject to change. The given example demonstrates the feasibility of the system; however it does not mandate the functionality as shown. Any algorithm that evaluates trust related information into the grant of a service might be subject to the invention.

1. System to grant or refuse access to a system, comprising a portable access device communicating with a terminal of an access point, wherein the portable access device comprises a storage means,
characterized in that a set of trust parameters is stored on the storage means, said set of trust parameters being used to evaluate the amount of service and/or functionality of the system, being granted to the user presenting the trust parameters on the portable access device, wherein the evaluation and the decision, whether to grant or refuse access to the system is made as a result of computation of the trust parameters without revealing the identity of the user.

2. System according to claim 1,
characterized in that the portable access device is a smart card or chip card that holds at least part of the trust parameters.

3. A method to grant or refuse access to a system, comprising
a portable access device communicating with a terminal of an access point, wherein the portable access device comprises a storage means,
characterized by
evaluating according to an algorithm the actual access rights of the user from a set of trust parameters in an anonymous way, and storing the set of trust parameters in the storage means, said set of trust parameters being used to evaluate the amount of service and/or functionality of the system being granted to the user presenting the trust parameters on the portable access device, wherein the evaluation and the decision whether to grant or refuse access to the system is made as a result of computation of the trust parameters without revealing the identity of the user.

4. A method according to claim 3,
characterized in changing the evaluation criteria of the algorithm depending on a set of working conditions (time of day, social events, political situation, emergency situation etc.).

5. A method according to claim 3,
characterized in linking to a registration instance to update the trust parameters.

6. A method in accordance with claim 3,
characterized in performing a biometric verification to authenticate the user before the set of trust parameters is presented, while the identity of the user remains protected.

7. A method in accordance with claim 3,
characterized in performing a mutual authentication between the device and the access point to assure that a genuine access device is communicating to a genuine access point.

8. A method in accordance with claim 3,
characterized in performing a biometric scan by the access point.

9. A method in accordance with claim 3,
characterized in performing a biometric scan by the access device.

10. A method in accordance with claim 3,
characterized in performing a biometric verification by the access device.

11. Method in accordance with claim 3,
characterized in performing a biometric verification by the access point.

12. A method according to claim 11,
characterized in sending by the access point at least part of the scanned biometric information of the user to the access device.

13. A method according to claim 12,
characterized in storing the biometric reference parameters in the access device.

14. A method according to claim 13,
characterized in verifying that the user is linked to the biometric reference parameters kept in the access device.

15. A method according to claim 14,
characterized in performing the final decision by the access device whether the scanned biometric data matches the biometric reference data stored in the access device.

16. A method according to claim 3,
characterized in performing in the access point the evaluation and the decision whether to grant or refuse access to the system.

17. A computer program product comprising a storage medium containing computer code for controlling a computer to perform the method in accordance with claims 3 to 16.
